(19) United States
(12) Patent Application Publication
(10) Pub. No.: US 2023/0342553 A1
(43) Pub. Date: Oct. 26, 2023

(54) ATTRIBUTE AND RATING CO-EXTRACTION

(71) Applicant: LEMON INC., Grand Cayman (KY)

(72) Inventors: Hongyu XIONG, Los Angeles, CA (US); Han WANG, Los Angeles, CA (US); Yiqi FENG, Los Angeles, CA (US); Rui LI, Los Angeles, CA (US); Yuan GAO, Los Angeles, CA (US); Xiangyu ZENG, Los Angeles, CA (US); Qingyi LU, Los Angeles, CA (US); Bin LIU, Los Angeles, CA (US)

(21) Appl. No.: 17/727,015

(22) Filed: Apr. 22, 2022

(51) Int. Cl. G06F 40/279; G06F 40/30; G06N 3/04

(52) U.S. Cl. CPC G06F 40/30; G06F 40/279; G06N 3/0454

(57) ABSTRACT

Embodiments of the present disclosure relate to attribute and rating co-extraction. According to embodiments of the present disclosure, a method is proposed. The method comprises: determining, by a first sub-network of a model, a first feature representation based on a first token contained in a text, the first feature representation indicating semantic information of the first token in the text; determining, by a second sub-network of the model, first attribute information associated with the first token based on the first feature representation, the first attribute information indicating a first attribute involved in the text; and determining, by a third sub-network of the model, first rating information associated with the first token based on the first feature representation, the first rating information indicating a rating related to the first attribute.

### FIELD

Embodiments of the present disclosure relates generally to computer techniques, and more particularly, to information co-extraction.

### BACKGROUND

With the rapid development of Internet, more and more users are accustomed to comment on entities, such as books and movies, on the Internet. Users may pay different attention to different attributes of a same entity and evaluate a same attribute of the same entity differently. The extraction of information contained in such reviews may be beneficial to build a knowledge graph of the corresponding entity and a better understanding of the entity.

### SUMMARY

Embodiments of the present disclosure provide a solution for attribute and rating co-extraction.

In a first aspect, a method for attribute and rating co-extraction is proposed. The method comprises: determining, by a first sub-network of a model, a first feature representation based on a first token contained in a text, the first feature representation indicating semantic information of the first token in the text; determining, by a second sub-network of the model, first attribute information associated with the first token based on the first feature representation, the first attribute information indicating a first attribute involved in the text; and determining, by a third sub-network of the model, first rating information associated with the first token based on the first feature representation, the first rating information indicating a rating related to the first attribute. The method in accordance with the first aspect of the present disclosure makes it possible to extract the attribute information and rating information at the same time. Compared with the conventional solution, the proposed method can advantageously extract information more efficiently.

In a second aspect, a system is proposed. The system comprises: at least one processor; and at least one memory communicatively coupled to the at least one processor and comprising computer-readable instructions that upon execution by the at least one processor cause the at least one processor to perform a method in accordance with the first aspect of the present disclosure.

In a third aspect, a non-transitory computer-readable storage medium is proposed. The non-transitory computer-readable storage medium stores computer-readable instructions that upon execution by a computing device cause the computing device to perform a method in accordance with the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent, wherein:

FIG. 1 illustrates a block diagram of an environment in which the embodiments of the present disclosure can be implemented;

FIG. 2 illustrates a block diagram of example architecture of a model in accordance with some example embodiments of the present disclosure;

FIG. 3 illustrates a schematic diagram of the model shown in FIG. 2 in form of a sequence in accordance with some example embodiments of the present disclosure;

FIG. 4 illustrates a flowchart of a method in accordance with some example embodiments of the present disclosure; and

FIG. 5 illustrates a block diagram of an example computing system/device suitable for implementing example embodiments of the present disclosure.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. At the application stage, the resulting machine learning model may be used to process an actual model input based on the set of parameter values obtained from the training process and to determine the corresponding model output.

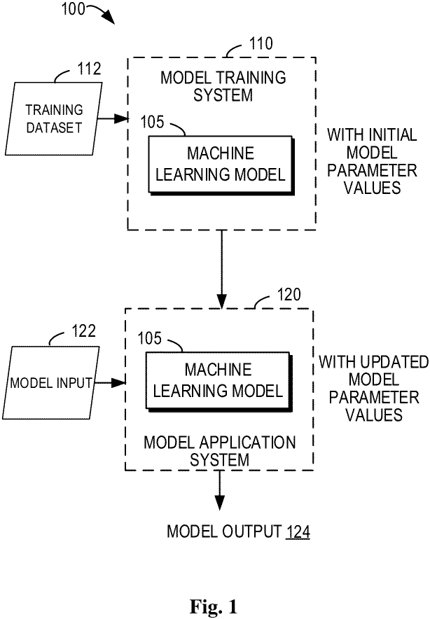

FIG. 1 illustrates a block diagram of an environment 100 in which the embodiments of the present disclosure can be implemented. In the environment 100, it is expected to train and apply a machine learning model 105 for a specific task, such as a prediction task or an information extraction task. The machine learning model 105 may be of any machine learning or deep learning architectures, for example, a neural network. The scope of the present disclosure is not limited in this respect.

In practical systems, the machine learning model 105 may be configured to process at least one model input and generate at least one model output indicating a prediction or classification result for the model input. The processing task may be defined depending on practical applications where the machine learning model 105 is applied.

The machine learning model 105 may be constructed as a function which processes the model input and generates a model output. The machine learning model 105 may be configured with a set of model parameters whose values are to be learned from training data through a training process. In FIG. 1, the model training system 110 is configured to implement the training process to train the machine learning model 105 based on a training dataset 112.

The training dataset 112 may include a large number of model inputs provided to the machine learning model 105 and labeling information indicating corresponding ground-truth outputs for the model inputs. At an initial stage, the machine learning model 105 may be configured with initial model parameter values. During the training process, the initial model parameter values of the machine learning model 105 may be iteratively updated until a learning objective is achieved.

After the training process, the trained machine learning model 105 configured with the updated model parameter values may be provided to the model application system 120 which applies a real-world model input 122 to the machine learning model 105 to output a model output 124 for the model input 122.

In FIG. 1, the model training system 110 and the model application system 120 may be any systems with computing capabilities. It should be appreciated that the components and arrangements in the environment shown in FIG. 1 are only examples, and a computing system suitable for implementing the example implementation described in the subject matter described herein may include one or more different components, other components, and/or different arrangement manners. For example, although shown as separate, the model training system 110 and the model application system 120 may be integrated in the same system or device. The scope of the present disclosure is not limited in this respect.

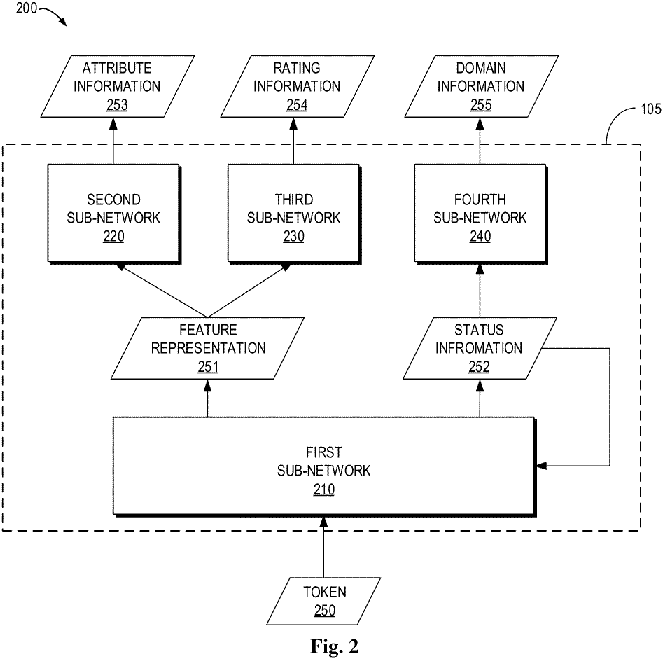

FIG. 2 illustrates a block diagram of example architecture of a model 105 in accordance with some example embodiments of the present disclosure. It should be understood that the model 105 may also include additional blocks not shown, and/or blocks shown may be omitted. The scope of the present disclosure is not limited in this respect.

As shown in FIG. 2, the model 105 receives a token contained in a text as input. In some embodiments, the text may be a movie review. In some embodiments, the text may be a book review. It should be understood that the text may be any other suitable text. The scope of the present disclosure is not limited in this respect. As used herein, the term “token” refers to an instance of a character or a sequence of characters that are group together as a useful semantic unit for processing. By way of example, the text “Very high quality sound.” contains following five tokens: “Very”, “high”, “quality”, “sound” and “.”.

As shown in FIG. 2, the model 105 may comprise four sub-networks, i.e., a first sub-network 210, a second sub-network 220, a third sub-network 230 and a fourth sub-network 240. The first sub-network 210 receives the token 250 as input. The first sub-network 210 determines a feature representation 251 based on the token. The feature representation 251 indicates the semantic information of the token 250 in the text. In some embodiments, the first sub-network 210 may determine an embedding vector (also referred to as “embedding”) of the token 250 and determine the feature representation 251 based on the embedding. In some embodiments, the embedding for a token 250 may be pre-trained by a language model, e.g., Glove, Word2vec, or bidirectional encoder representations from transformers (BERT), etc. In some embodiments, the determined feature representation 251 may also be in form of an embedding.

In some embodiments, the first sub-network 210 may comprise a long short-term memory (LSTM) unit or a BERT unit. It should be understood that the first sub-network 210 may comprise any other suitable unit for natural language processing. The scope of the present disclosure is not limited in this respect.

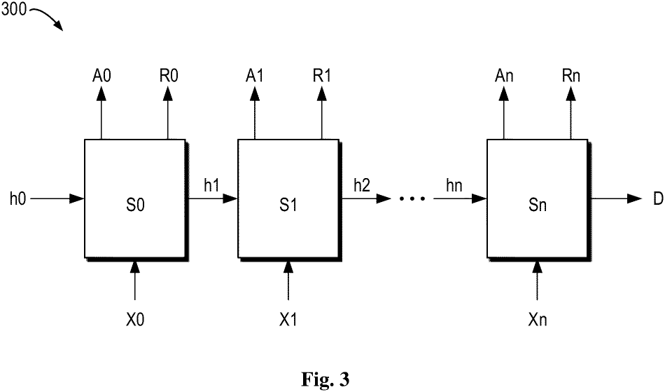

The first sub-network 210 may further determine status information 252 associated the token. The status information 252 indicates the status of the first sub-network 210 and may be used to pass the current status of the first sub-network 210 to next step. For example, the first sub-network 210 may determine a feature presentation for a token 250 based on the token 250 and the previous status of the first sub-network 210. This will be illustrated below with reference to FIG. 3.

The second sub-network 220 may receive the feature representation 251 as input and determine attribute information 253 based on the feature representation 251. The attribute information 253 indicates an attribute involved in the text. In some embodiments, for an entity, a set of attributes may be acquired from a knowledge graph related to the entity. For example, attributes associated with a headset may comprise at least one of comfortableness, sound and microphone. The attribute information 253 may indicate one attribute among the set of attributes.

In some embodiments, the second sub-network 220 may comprise a multi-layer neural network. The multi-layer neural network converts an input embedding vector of a first size (e.g., 10×1) to an output embedding vector of a second size (e.g., 5×1). In this case, the attribute information 253 may correspond to the output embedding vector. It should be understood that instead of a multi-layer neural network, the second sub-network 220 may also be implemented through any other suitable architecture. The scope of the present disclosure is not limited in this respect.

In some embodiments, the embedding for each attribute may be pre-trained by a language model, e.g., Glove, Word2vec, or BERT, etc. By employing pre-trained embedding, the model 105 is able to identify similar attributes across different domains more efficiently. It should be understood that instead of the pre-trained embedding, a random-initialized embedding may also be employed. The scope of the present disclosure is not limited in this respect.

The third sub-network 230 may receive the feature representation 251 as input and determine rating information 254 based on the feature representation 251. The rating information 254 indicates a rating related to the attribute. In some embodiments, the rating may be one of a set of predefined rating values, e.g. -1, 0 and 1, wherein -1 indicates a negative evaluation, 1 indicates a positive evaluation and 0 indicates a neutral evaluation. By way of example, for the review “Very high quality sound.”, it may be determined that the rating value of the attribute “sound” is 1. It should be understood that the above rating values are merely exemplary and does not limit the scope the present disclosure.

In some embodiments, the third sub-network 230 may also comprise a multi-layer neural network. The multi-layer neural network converts an input embedding vector of a first size (e.g., 10×1) to an output embedding vector of a second size (e.g., 1×1). In this case, the rating information 254 may correspond to the output embedding vector. It should be understood that instead of a multi-layer neural network, the third sub-network 230 may also be implemented through any other suitable architecture. The scope of the present disclosure is not limited in this respect.

The fourth sub-network 240 may receive the status information 252 as input and determine domain information 255 associated with the token. The domain information 255 indicates a domain involved by the token. Similar with the second sub-network 220 and the third sub-network 230, the fourth sub-network 240 may also comprise a multi-layer neural network which converts an input embedding vector of a first size (e.g., 7×1) to an output embedding vector of a second size (e.g., 2×1). In this case, the domain information 255 may correspond to the output embedding vector. It should be understood that instead of a multi-layer neural network, the fourth sub-network 240 may also be implemented through any other suitable architecture. The scope of the present disclosure is not limited in this respect. In some embodiment, domain information 255 determined based on the last token in the text may be regard as domain information associated with the text which indicates a domain involved by the text.

FIG. 3 illustrates a schematic diagram of the model 105 shown in FIG. 2 in form of a sequence in accordance with some example embodiments of the present disclosure. For the purpose of illustration, it is assumed that the text contains n tokens, i.e., X0, X1, ..., Xn. Each of the n tokens is input to the model 105 sequentially.

Models S0, S1, ..., Sn represent the respective model 105 for processing each of the n tokens. For example, the model S0 processes the first token S0 in the text, while the model Sn processes the last token Xn in the text.

Status information h0 represents the initial status of the model 105. In some embodiment, status information h0 may be an all-zero embedding. In some embodiments, status information h0 may also be a random-initialized embedding. The scope of the present disclosure is not limited in this respect. As stated above, status information h1, h2, ..., hn pass the status of the model to next step. For example, status information h1 passes the status of the model S0 to model S1. In this regard, the model 105 can be considered as a sequence-based model.

Attribute information AO, A1, ..., An are respective attribute information determined for the n tokens X0, X1, ..., Xn, and rating information R0, R1, ..., Rn are the respective rating information determined for the n tokens X0, X1, ..., Xn. After the attribute information and rating information are determined for all of the tokens in the text by the model. All of the attribute information and rating information can be analyzed statistically to determine target attribute information and target rating information associated with the text. The target attribute information indicates a set of attributes involved in the text and the target rating information indicates a respective rating of each of the set of attributes. By way of example, a set of ratings of a same attribute determined from a set of tokens contained in a same text can be averaged to obtain an overall rating of the attribute. It should be understood that the attribute information and rating information can be analyzed in any other suitable manner to obtain the target attribute information and the target rating information. The scope of the present disclosure is not limited in this respect.

As shown in FIG. 3, the model Sn determines domain information D based on the last token Xn and the previous status information hn. As stated above, domain information D determined based on the last token Xn may be regard as domain information associated with the text which indicates a domain involved by the text. By way of example, the domain of the text “Comfortable. Very high quality sound. Mic is good too.” may be determined as “merchandise”, since a headset belongs to merchandise.

The model 105 discussed above can be trained with a predetermined training dataset 112. For the purpose of illustration, a training dataset 112 related to reviews will be discussed below. The scope of the present disclosure is not limited in this respect. Domains of review texts (such as movie, book, merchandise, restaurant, scenery spot, etc.) can be extracted from a public dataset. Attributes related to an entity may be acquired from a public knowledge graph related to the entity. For each of the attributes, a pre-trained embedding can be used as a label for the training. A large number of review texts may be extracted from public database. In some embodiments, these review texts can be tagged though computer program automatically. In some embodiments, these review texts can be tagged manually. In some embodiments, these review texts can be tagged though a combination of automatic tagging and manual tagging. As stated with reference to FIG. 1, the initial model parameter values of the model 105 may be iteratively updated through the training dataset 112 until a learning objective is achieved. The trained model 105 can be applied to any dataset to build a knowledge graph based on entities, domains, attributes and corresponding ratings.

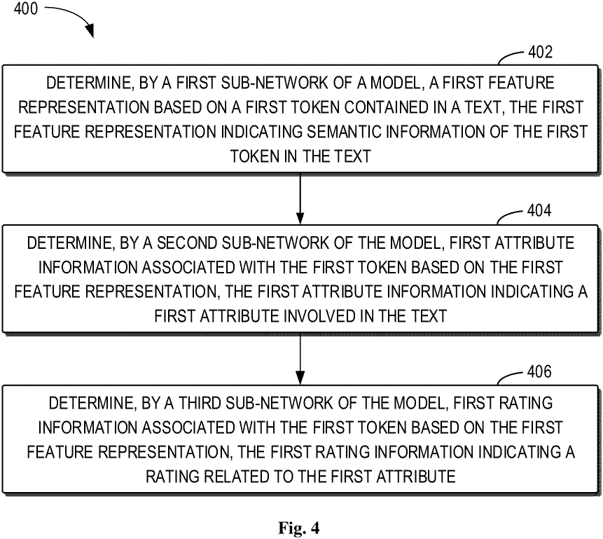

FIG. 4 illustrates a flowchart of a method 400 in accordance with some example embodiments of the present disclosure. For example, method 400 may be performed by the model 105 training system 110 and the model 105 application system 120 as shown in FIG. 1. It should be understood that the method 400 may also include additional blocks not shown, and/or blocks shown may be omitted. The scope of the present disclosure is not limited in this respect. For ease of description, the method 400 is described below with reference to FIGS. 1-3.

At block 402, a first sub-network 210 of a model 105 may determine a first feature representation based on a first token contained in a text. The first feature representation indicates semantic information of the first token in the text.

At block 404, a second sub-network 220 of the model 105 may determine first attribute information associated with the first token based on the first feature representation. The first attribute information indicates a first attribute involved in the text.

At block 406, a third sub-network 230 of the model 105 may determine first rating information associated with the first token based on the first feature representation. The first rating information indicates a rating related to the first attribute.

In some embodiments, the text may further comprise a second token following the first token. Determining the first feature representation comprises: obtaining first status information associated with the first token, the first status information indicating a status of the first sub-network 210. The method 400 further comprises: determining, by the first sub-network 210, a second feature representation based on the second token and the first status information, the second feature representation indicating the semantic information of the second token in the text; determining, by the second sub-network 220, a second attribute information associated with the second token based on the second feature representation, the second attribute information indicating a second attribute involved in the text; and determining, by the third sub-network 230, a second rating information associated with the second token based on the second feature representation, the second rating information indicating a rating related to the second attribute.

In some embodiments, the second token may correspond to a last token in the text. The model 105 may further comprise a fourth sub-network 240. Determining the second feature representation comprises: obtaining second status information associated with the second token, the second status information indicating a status of the first sub-network 210. The method 400 further comprises: determining, by the fourth sub-network 240, domain information associated with the text, the domain information indicating a domain involved by the text.

In some embodiments, the method 400 may further comprise: determining target attribute information associated with the text based on the first attribute information and the second attribute information, the target attribute information indicating a set of attributes involved in the text; and determining target rating information associated with the text based on the first rating information and the second rating information, the target rating information indicating a respective rating of each of the set of attributes.

In some embodiments, determining the first feature representation comprises: determining an embedding of the first token; and determining the first feature representation based on the embedding. In some embodiments, the embedding is pre-trained by a language model.

In some embodiments, the first sub-network 210 may comprise a long short-term memory (LSTM) unit. In some embodiments, the first sub-network 210 may comprise a bidirectional encoder representations from transformers (BERT) unit.

As discussed above, an all-in-one model is proposed herein, which is capable of extracting attribute, rating of the attribute and domain involved in a text at the same time. Thereby, the co-extraction of attribute and rating of cross-domain entity can be achieved and the desired information can be extracted more efficiently and accurately. It should be understood that although the model is used to extract attribute and rating herein, the model in accordance with some example embodiments of the present disclosure may also be used to enable co-extraction of any other suitable information. The scope of the present disclosure is not limited in this respect.

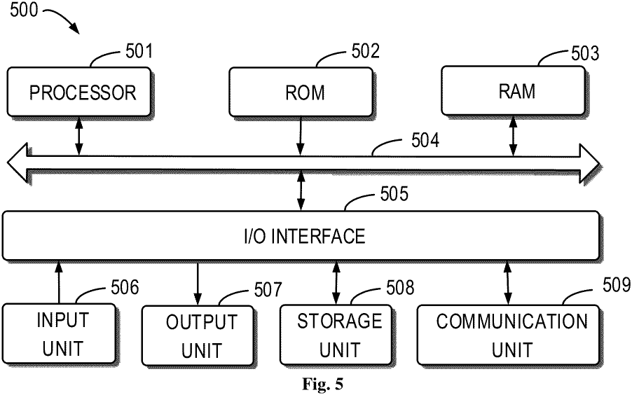

FIG. 5 illustrates a block diagram of an example computing system/device 500 suitable for implementing example embodiments of the present disclosure. The model training system 110 and/or the model application system 120 may be implemented as or included in the system/device 500. The system/device 500 may be a general-purpose computer, a physical computing device, or a portable electronic device, or may be practiced in distributed cloud computing environments where tasks are performed by remote processing devices that are linked through a communication network. The system/device 500 can be used to implement any of the processes described herein.

As depicted, the system/device 500 includes a processor 501 which is capable of performing various processes according to a program stored in a read only memory (ROM) 502 or a program loaded from a storage unit 508 to a random access memory (RAM) 503. In the RAM 503, data required when the processor 501 performs the various processes or the like is also stored as required. The processor 501, the ROM 502 and the RAM 503 are connected to one another via a bus 504. An input/output (I/O) interface 505 is also connected to the bus 504.

The processor 501 may be of any type suitable to the local technical network and may include one or more of the following: general purpose computers, special purpose computers, microprocessors, digital signal processors (DSPs), graphic processing unit (GPU), co-processors, and processors based on multicore processor architecture, as non-limiting examples. The system/device 500 may have multiple processors, such as an application-specific integrated circuit chip that is slaved in time to a clock which synchronizes the main processor.

A plurality of components in the system/device 500 are connected to the I/O interface 505, including an input unit 506, such as a keyboard, a mouse, or the like; an output unit 507 including a display such as a cathode ray tube (CRT), a liquid crystal display (LCD), or the like, and a loudspeaker or the like; the storage unit 508, such as disk and optical disk, and the like; and a communication unit 509, such as a network card, a modem, a wireless transceiver, or the like. The communication unit 509 allows the system/device 500 to exchange information/data with other devices via a communication network, such as the Internet, various telecommunication networks, and/or the like.

The methods and processes described above, such as the method 400, can also be performed by the processor 501. In some embodiments, the method 400 can be implemented as a computer software program or a computer program product tangibly included in the computer readable medium, e.g., storage unit 508. In some embodiments, the computer program can be partially or fully loaded and/or embodied to the system/device 500 via ROM 502 and/or communication unit 509. The computer program includes computer executable instructions that are executed by the associated processor 501. When the computer program is loaded to RAM 503 and executed by the processor 501, one or more acts of the method 400 described above can be implemented. Alternatively, processor 501 can be configured via any other suitable manners (e.g., by means of firmware) to execute the method 400 in other embodiments.

In some example embodiments of the present disclosure, there is provided a computer program product comprising instructions which, when executed by a processor of an apparatus, cause the apparatus to perform steps of any one of the methods described above.

In some example embodiments of the present disclosure, there is provided a computer readable medium comprising program instructions for causing an apparatus to perform at least steps of any one of the methods described above. The computer readable medium may be a non-transitory computer readable medium in some embodiments.

In some example embodiments of the present disclosure, there is provided a computer readable medium comprising program instructions for causing an apparatus to perform steps of any one of the methods described above. The computer readable medium may be a non-transitory computer readable medium in some embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods/processes as described above. Generally, program modules include routines, programs, libraries, objects, classes, components, data structures, or the like that perform particular tasks or implement particular abstract types. The functionality of the program modules may be combined or split between program modules as desired in various embodiments. Computer-executable instructions for program modules may be executed within a local or distributed device. In a distributed device, program modules may be located in both local and remote storage media.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. The program code may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Implementations of the present disclosure can be described in view of the following clauses, the features of which can be combined in any reasonable manner.

Clause 1. A method, comprising: determining, by a first sub-network of a model, a first feature representation based on a first token contained in a text, the first feature representation indicating semantic information of the first token in the text; determining, by a second sub-network of the model, first attribute information associated with the first token based on the first feature representation, the first attribute information indicating a first attribute involved in the text; and determining, by a third sub-network of the model, first rating information associated with the first token based on the first feature representation, the first rating information indicating a rating related to the first attribute.

Clause 2. The method of Clause 1, wherein the text further comprises a second token following the first token, determining the first feature representation comprises: obtaining first status information associated with the first token, the first status information indicating a status of the first sub-network; and the method further comprises: determining, by the first sub-network, a second feature representation based on the second token and the first status information, the second feature representation indicating the semantic information of the second token in the text; determining, by the second sub-network, a second attribute information associated with the second token based on the second feature representation, the second attribute information indicating a second attribute involved in the text; and determining, by the third sub-network, a second rating information associated with the second token based on the second feature representation, the second rating information indicating a rating related to the second attribute.

Clause 3. The method of Clause 2, wherein the second token corresponds to a last token in the text, the model further comprises a fourth sub-network, determining the second feature representation comprises: obtaining second status information associated with the second token, the second status information indicating a status of the first sub-network; and the method further comprises: determining, by the fourth sub-network, domain information associated with the text, the domain information indicating a domain involved by the text.

Clause 4. The method of Clause 2, further comprising: determining target attribute information associated with the text based on the first attribute information and the second attribute information, the target attribute information indicating a set of attributes involved in the text; and determining target rating information associated with the text based on the first rating information and the second rating information, the target rating information indicating a respective rating of each of the set of attributes.

Clause 5. The method of Clause 1, wherein determining the first feature representation comprises: determining an embedding of the first token; and determining the first feature representation based on the embedding.

Clause 6. The method of Clause 5, wherein the embedding is pre-trained by a language model.

Clause 7. The method of Clause 1, wherein the first sub-network comprises a long short-term memory (LSTM) unit or a bidirectional encoder representations from transformers (BERT) unit.

Clause 8. A system, comprising: at least one processor; and at least one memory communicatively coupled to the at least one processor and comprising computer-readable instructions that upon execution by the at least one processor cause the at least one processor to perform actions comprising: determining, by a first sub-network of a model, a first feature representation based on a first token contained in a text, the first feature representation indicating semantic information of the first token in the text; determining, by a second sub-network of the model, first attribute information associated with the first token based on the first feature representation, the first attribute information indicating a first attribute involved in the text; and determining, by a third sub-network of the model, first rating information associated with the first token based on the first feature representation, the first rating information indicating a rating related to the first attribute.

Clause 9. The system of Clause 8, wherein the text further comprises a second token following the first token, determining the first feature representation comprises: obtaining first status information associated with the first token, the first status information indicating a status of the first sub-network; and the actions further comprises: determining, by the first sub-network, a second feature representation based on the second token and the first status information, the second feature representation indicating the semantic information of the second token in the text; determining, by the second sub-network, a second attribute information associated with the second token based on the second feature representation, the second attribute information indicating a second attribute involved in the text; and determining, by the third sub-network, a second rating information associated with the second token based on the second feature representation, the second rating information indicating a rating related to the second attribute.

Clause 10. The method of Clause 9, wherein the second token corresponds to a last token in the text, the model further comprises a fourth sub-network, determining the second feature representation comprises: obtaining second status information associated with the second token, the second status information indicating a status of the first sub-network; and the actions further comprises: determining, by the fourth sub-network, domain information associated with the text, the domain information indicating a domain involved by the text.

Clause 11. The system of Clause 9, wherein the actions further comprises: determining target attribute information associated with the text based on the first attribute information and the second attribute information, the target attribute information indicating a set of attributes involved in the text; and determining target rating information associated with the text based on the first rating information and the second rating information, the target rating information indicating a respective rating of each of the set of attributes.

Clause 12. The system of Clause 8, wherein determining the first feature representation comprises: determining an embedding of the first token; and determining the first feature representation based on the embedding.

Clause 13. The system of Clause 12, wherein the embedding is pre-trained by a language model.

Clause 14. The system of Clause 8, wherein the first sub-network comprises a long short-term memory (LSTM) unit or a bidirectional encoder representations from transformers (BERT) unit.

Clause 15. A non-transitory computer-readable storage medium, storing computer-readable instructions that upon execution by a computing device cause the computing device to perform actions comprising: determining, by a first sub-network of a model, a first feature representation based on a first token contained in a text, the first feature representation indicating semantic information of the first token in the text; determining, by a second sub-network of the model, first attribute information associated with the first token based on the first feature representation, the first attribute information indicating a first attribute involved in the text; and determining, by a third sub-network of the model, first rating information associated with the first token based on the first feature representation, the first rating information indicating a rating related to the first attribute.

Clause 16. The non-transitory computer-readable storage medium of Clause 15, wherein the text further comprises a second token following the first token, determining the first feature representation comprises: obtaining first status information associated with the first token, the first status information indicating a status of the first sub-network; and the actions further comprises: determining, by the first sub-network, a second feature representation based on the second token and the first status information, the second feature representation indicating the semantic information of the second token in the text; determining, by the second sub-network, a second attribute information associated with the second token based on the second feature representation, the second attribute information indicating a second attribute involved in the text; and determining, by the third sub-network, a second rating information associated with the second token based on the second feature representation, the second rating information indicating a rating related to the second attribute.

Clause 17. The non-transitory computer-readable storage medium of Clause 16, wherein the second token corresponds to a last token in the text, the model further comprises a fourth sub-network, determining the second feature representation comprises: obtaining second status information associated with the second token, the second status information indicating a status of the first sub-network; and the actions further comprises: determining, by the fourth sub-network, domain information associated with the text, the domain information indicating a domain involved by the text.

Clause 18. The non-transitory computer-readable storage medium of Clause 17, wherein the actions further comprises: determining target attribute information associated with the text based on the first attribute information and the second attribute information, the target attribute information indicating a set of attributes involved in the text; and determining target rating information associated with the text based on the first rating information and the second rating information, the target rating information indicating a respective rating of each of the set of attributes.

Clause 19. The non-transitory computer-readable storage medium of Clause 15, wherein determining the first feature representation comprises: determining an embedding of the first token; and determining the first feature representation based on the embedding.

Clause 20. The non-transitory computer-readable storage medium of Clause 19, wherein the embedding is pre-trained by a language model.

Clause 21. The non-transitory computer-readable storage medium of Clause 15, wherein the first sub-network comprises a long short-term memory (LSTM) unit or a bidirectional encoder representations from transformers (BERT) unit.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A method, comprising:
determining, by a first sub-network of a model, a first feature representation based on a first token contained in a text, the first feature representation indicating semantic information of the first token in the text;
determining, by a second sub-network of the model, first attribute information associated with the first token based on the first feature representation, the first attribute information indicating a first attribute involved in the text; and
determining, by a third sub-network of the model, first rating information associated with the first token based on the first feature representation, the first rating information indicating a rating related to the first attribute.

2. The method of claim 1, wherein the text further comprises a second token following the first token,
determining the first feature representation comprises:
obtaining first status information associated with the first token, the first status information indicating a status of the first sub-network; and
the method further comprises:
determining, by the first sub-network, a second feature representation based on the second token and the first status information, the second feature representation indicating the semantic information of the second token in the text;
determining, by the second sub-network, a second attribute information associated with the second token based on the second feature representation, the second attribute information indicating a second attribute involved in the text; and
determining, by the third sub-network, a second rating information associated with the second token based on the second feature representation, the second rating information indicating a rating related to the second attribute.

3. The method of claim 2, wherein the second token corresponds to a last token in the text, the model further comprises a fourth sub-network,
determining the second feature representation comprises:
obtaining second status information associated with the second token, the second status information indicating a status of the first sub-network; and
the method further comprises:
determining, by the fourth sub-network, domain information associated with the text, the domain information indicating a domain involved by the text.

4. The method of claim 2, further comprising:
determining target attribute information associated with the text based on the first attribute information and the second attribute information, the target attribute information indicating a set of attributes involved in the text; and
determining target rating information associated with the text based on the first rating information and the second rating information, the target rating information indicating a respective rating of each of the set of attributes.

5. The method of claim 1, wherein determining the first feature representation comprises:
determining an embedding of the first token; and
determining the first feature representation based on the embedding.

6. The method of claim 5, wherein the embedding is pre-trained by a language model.

7. The method of claim 1, wherein the first sub-network comprises a long short-term memory (LSTM) unit or a bidirectional encoder representations from transformers (BERT) unit.

8. A system, comprising:
at least one processor; and
at least one memory communicatively coupled to the at least one processor and comprising computer-readable instructions that upon execution by the at least one processor cause the at least one processor to perform actions comprising:
determining, by a first sub-network of a model, a first feature representation based on a first token contained in a text, the first feature representation indicating semantic information of the first token in the text;
determining, by a second sub-network of the model, first attribute information associated with the first token based on the first feature representation, the first attribute information indicating a first attribute involved in the text; and
determining, by a third sub-network of the model, first rating information associated with the first token based on the first feature representation, the first rating information indicating a rating related to the first attribute.

9. The system of claim 8, wherein the text further comprises a second token following the first token,
determining the first feature representation comprises:
obtaining first status information associated with the first token, the first status information indicating a status of the first sub-network; and
the actions further comprises:
determining, by the first sub-network, a second feature representation based on the second token and the first status information, the second feature representation indicating the semantic information of the second token in the text;
determining, by the second sub-network, a second attribute information associated with the second token based on the second feature representation, the second attribute information indicating a second attribute involved in the text; and
determining, by the third sub-network, a second rating information associated with the second token based on the second feature representation, the second rating information indicating a rating related to the second attribute.

10. The method of claim 9, wherein the second token corresponds to a last token in the text, the model further comprises a fourth sub-network,
determining the second feature representation comprises:
obtaining second status information associated with the second token, the second status information indicating a status of the first sub-network; and
the actions further comprises:
determining, by the fourth sub-network, domain information associated with the text, the domain information indicating a domain involved by the text.

11. The system of claim 9, wherein the actions further comprises:
determining target attribute information associated with the text based on the first attribute information and the second attribute information, the target attribute information indicating a set of attributes involved in the text; and
determining target rating information associated with the text based on the first rating information and the second rating information, the target rating information indicating a respective rating of each of the set of attributes.

12. The system of claim 8, wherein determining the first feature representation comprises:
determining an embedding of the first token; and
determining the first feature representation based on the embedding.

13. The system of claim 12, wherein the embedding is pre-trained by a language model.

14. The system of claim 8, wherein the first sub-network comprises a long short-term memory (LSTM) unit or a bidirectional encoder representations from transformers (BERT) unit.

15. A non-transitory computer-readable storage medium, storing computer-readable instructions that upon execution by a computing device cause the computing device to perform actions comprising:
determining, by a first sub-network of a model, a first feature representation based on a first token contained in a text, the first feature representation indicating semantic information of the first token in the text;
determining, by a second sub-network of the model, first attribute information associated with the first token based on the first feature representation, the first attribute information indicating a first attribute involved in the text; and
determining, by a third sub-network of the model, first rating information associated with the first token based on the first feature representation, the first rating information indicating a rating related to the first attribute.

16. The non-transitory computer-readable storage medium of claim 15, wherein the text further comprises a second token following the first token,
determining the first feature representation comprises:
obtaining first status information associated with the first token, the first status information indicating a status of the first sub-network; and
the actions further comprises:
determining, by the first sub-network, a second feature representation based on the second token and the first status information, the second feature representation indicating the semantic information of the second token in the text;
determining, by the second sub-network, a second attribute information associated with the second token based on the second feature representation, the second attribute information indicating a second attribute involved in the text; and
determining, by the third sub-network, a second rating information associated with the second token based on the second feature representation, the second rating information indicating a rating related to the second attribute.

17. The non-transitory computer-readable storage medium of claim 16, wherein the second token corresponds to a last token in the text, the model further comprises a fourth sub-network,
determining the second feature representation comprises:
obtaining second status information associated with the second token, the second status information indicating a status of the first sub-network; and
the actions further comprises:
determining, by the fourth sub-network, domain information associated with the text, the domain information indicating a domain involved by the text.

18. The non-transitory computer-readable storage medium of claim 17, wherein the actions further comprises:
determining target attribute information associated with the text based on the first attribute information and the second attribute information, the target attribute information indicating a set of attributes involved in the text; and
determining target rating information associated with the text based on the first rating information and the second rating information, the target rating information indicating a respective rating of each of the set of attributes.

19. The non-transitory computer-readable storage medium of claim 15, wherein determining the first feature representation comprises:
determining an embedding of the first token; and
determining the first feature representation based on the embedding.

20. The non-transitory computer-readable storage medium of claim 19, wherein the embedding is pre-trained by a language model.
